(19) United States
(12) Patent Application Publication
(10) Pub. No.: US 2015/0161146 A1
(43) Pub. Date: Jun. 11, 2015

(54) Communication Record Arrangement Method And Device

(71) Applicant: TENCENT TECHNOLOGY (SHENZHEN) COMPANY LIMITED, Shenzhen City (CN)

(72) Inventors: Yu LEI, Shenzhen (CN); Jing HE, Shenzhen (CN)

(21) Appl. No.: 14/621,756

(22) Filed: Feb. 13, 2015

Related U.S. Application Data
(63) Continuation of application No. PCT/CN2013/082033, filed on Aug. 22, 2013.

(30) Foreign Application Priority Data
Aug. 24, 2012 (CN) 201210305560.9

(51) Int. Cl. G06F 17/30

(52) U.S. Cl. CPC G06F 17/30076

(57) ABSTRACT

A method communication records including acquiring a communication record; obtaining an identifier and type corresponding to the communication record; merging a same type of communication records having a same identifier into one merged record; and arranging all the merged records in a same interface. Similar type of communication records having the same identifier are merged as one merged record, and all the merged records are arranged in the same interface, so that the user may not differentiate operations on different types of communication records when reading communication information.

### CROSS-REFERENCE TO RELATED APPLICATIONS

This application is a continuation of International Application No. PCT/CN2013/082033 filed on Aug. 22, 2013. This application claims the benefit and priority of Chinese Application No. 201210305560.9, filed Aug. 24, 2012. The entire disclosures of each of the above applications are incorporated herein by reference.

### FIELD

The present disclosure relates to a method and device for arranging communication records.

### BACKGROUND

This section provides background information related to the present disclosure which is not necessarily prior art.

With the development of Internet technologies, there are various types of communication records in a mobile terminal, for example, a short message, a call log, etc. Currently, displaying communication records in most mobile terminals are designed according to the types of communication records, for example, arranging and displaying different types of communication records using different interfaces. For example, all the short messages are arranged in a list of one interface and all the call logs are arranged in a list of another interface.

### SUMMARY

This section provides a general summary of the disclosure, and is not a comprehensive disclosure of its full scope or all of its features.

In order to solve the problem in the prior art, various embodiments provide a method and device for arranging communication records.

In one aspect, the present disclosure provides a method for arranging communication records, comprising:

acquiring a communication record;

obtaining an identifier and type corresponding to the communication record;

merging a same type of communication records having a same identifier into one merged record; and

arranging all the merged records in a same interface.

In another aspect, the present disclosure provides a device for arranging communication records, comprising:

an acquiring module, configured to acquire a communication record;

a recording module, configured to obtain an identifier and type corresponding to the communication record;

a merging module, configured to merge a same type of communication records having a same identifier into one merged record; and

an arranging module, configured to arrange all the merged records in a same interface.

In yet another aspect, the present disclosure also provides a device for arranging communication records. The device comprises a processor and a memory communicated with the processor. In the memory, the instructions that are executed by the processor are stored, comprising an acquiring instruction, a recording instruction, a merging instruction, and an arranging instruction, wherein

the acquiring instruction indicates to acquire a communication record;

the recording instruction indicates to obtain an identifier and type corresponding to the communication record;

the merging instruction indicates to merge a same type of communication records having a same identifier into one merged record; and

the arranging instruction indicates to arrange all the merged records in the same interface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In order to make technical solutions of various embodiments clearer, accompanying drawings to be used in description of the various embodiments will be simply introduced hereinafter. Obviously, the accompanying drawings to be described hereinafter are only some examples of the present disclosure. Those skilled in the art may obtain other drawings according to these accompanying drawings without creative labor.

FIG. 1 is a diagram illustrating a method for arranging communication records according to various embodiments of the present disclosure;

FIG. 2 is a diagram illustrating a method for arranging communication records according to various embodiments of the present disclosure;

FIG. 3A is a diagram illustrating a method for merging records according to various embodiments of the present disclosure;

FIG. 3B is a diagram illustrating displaying the records merged in FIG. 3A according to various embodiments of the present disclosure;

FIG. 4 is a diagram illustrating a method for merging records according to various embodiments of the present disclosure;

FIG. 5 is a diagram illustrating a structure of a device for arranging communication records according to various embodiments of the present disclosure;

FIG. 6 is a diagram illustrating a structure of a device for arranging communication records according to various embodiments of the present disclosure; and

FIG. 7 is a diagram illustrating a structure of a device for arranging communication records according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

In the existing method, when the user needs to review different types of communication records, a manual change from one interface to another interface is required. If the mobile terminal used by the user is controlled by button presses, it is possible that several button presses must occur to finish the switching of interfaces, which inconveniences the user.

The present disclosure will be illustrated in detail hereinafter with reference to the accompanying drawings and specific examples.

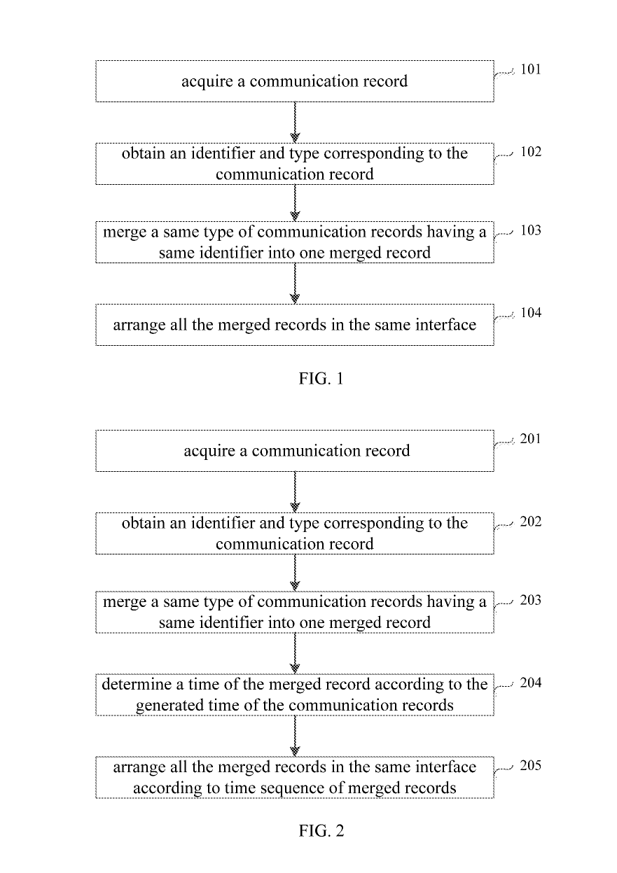

The present disclosure provides a method for arranging communication records. As shown in FIG. 1, the method includes the following procedures.

Block 101: acquire a communication record. The communication record generally refers to a record of receiving or sending by the mobile terminal and records generated by related operations.

Block 102: obtain an identifier and type corresponding to the communication record. Generally, the identifier corresponding to the communication record may be a number of a sender of the communication record. If the relevant contact of the communication record is stored in the local mobile terminal in terms of its name, the identifier corresponding to the communication record may be the locally stored name of the relevant contact of the communication record. According to different functions, the communication record can be defined with different types, for example, a short message, a call log, etc.

Block 103: merge a same type of communication records having a same identifier into one merged record. Because there may be multiple communication records having the same identifier, one single identifier may correspond to multiple short messages or multiple call logs. The same type of communication records having the same identifier are merged into one merged record. For example, if communication records with an identifier of “ZhangSan” correspond to three short messages or two call logs, those three short messages corresponding to “ZhangSan” are merged into one merged record, and those two call logs corresponding to “ZhangSan” are merged into another merged record.

Block 104: arrange all the merged records in the same interface. In various implementations, all the merged records may be arranged in the same interface, such that all the merged records after merging can be displayed in a list of the same interface.

As described above, according to the method for arranging communication records provided by various embodiments of the present disclosure, the communication records are classified and merged as merged records, and all the merged records are arranged in the same interface, so that all the communication records can be displayed in the same interface, and the user may not differentiate operations on different types of communication records when reading communication information, which makes the operation and reading more convenient.

Various embodiments of the present disclosure provide another method for arranging communication records. As shown in FIG. 2, the method includes the following procedures.

Block 201: acquire a communication record. The communication record generally refers to a record of receiving or sending by the mobile terminal and records generated by related operations.

Block 202: obtain an identifier and type corresponding to the communication record. Generally, the identifier corresponding to the communication record may be a number of a sender of the communication record. If the relevant contact of the communication record is stored in the local mobile terminal in terms of its name, the identifier corresponding to the communication record may be the locally stored name of the relevant contact of the communication record. According to different functions, the communication record can be defined with different types, for example, a short message, a call log, etc.

In order to better arrange communication records and merged records, a user may obtain a generated time of the communication record at the same time. The generated time of the communication record may refer to the time when a communication record is received, sent or operated by the local mobile terminal. For example, for a communication record with the type of short message, its generated time may be the time when the short message is received or sent. For a communication record with the type of call log, its generated time may be the time when receiving a phone call, the time when un-answering an incoming call, or the time when dialing an outgoing call, etc.

Block 203: merge a same type of communication records having a same identifier into one merged record. In various embodiments, a same identifier may correspond to multiple communication records. For example, one identifier may correspond to multiple short messages or multiple call logs. In order to make the merged records more organized, the same type of communication records having the same identifier may be merged into one merged record. For example, if communication records with an identifier of “ZhangSan” correspond to three short messages or two call logs, those three short messages corresponding to “ZhangSan” are merged into one merged record, and those two call logs corresponding to “ZhangSan” are merged into another merged record. In the similar manner, all the same type of communication records having the same identifier in the mobile terminal can be merged to obtain corresponding merged records.

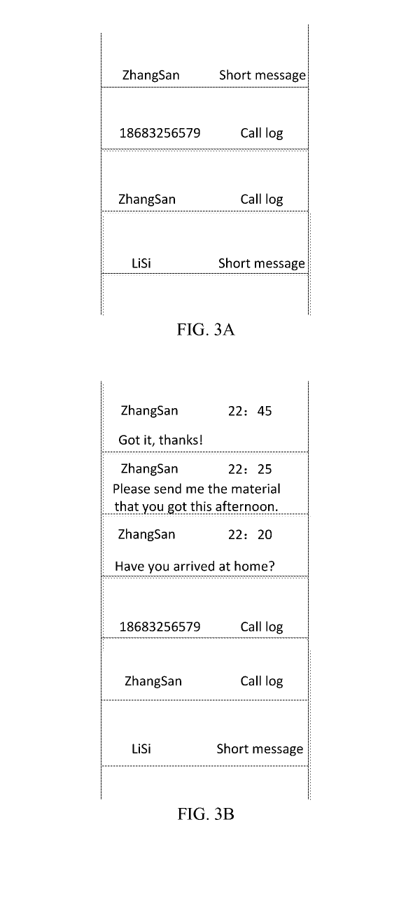

In general, there may be several ways of displaying merged records. For example, for each merged record, it may only record the identifier and the type of the communication records corresponding to the identifier. As shown in FIG. 3A, for the first merged record, the corresponding identifier is “ZhangSan”, the corresponding type of the communication records is “short message”; for the second merged record, the corresponding identifier is “18683256579”, the corresponding type of the communication records is “call log”; for the third merged record, the corresponding identifier is “ZhangSan”, the corresponding type of the communication records is “call log”; and for the fourth merged record, the corresponding identifier is “LiSi”, the corresponding type of the communication records is “short message”. In practical operation, with respect to this kind of displaying manner, when the user needs to check specific communication records corresponding to each merged record, it needs to select the merged record to enter the list of the specific communication records corresponding to the merged record. For example, after operating the first merged record in FIG. 3A, the specific communication records corresponding to the first merged record can be displayed. The results are shown in FIG. 3B, where after the merged record with the type of “short message” and having the identifier of “ZhangSan” is unfolded, three corresponding short messages are displayed, while other merged records are not selected, so that they are still in the merged state. In implementation, the unfolded communication records with the same type and having the same identifier may be directly displayed at the position of the merged record in the original interface, i.e., as shown in FIG. 3B, or the communication records corresponding to the merged record may also be displayed separately through another interface.

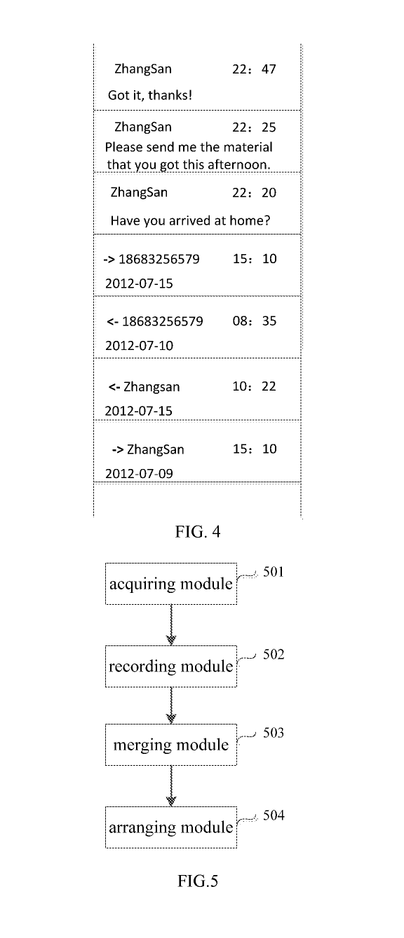

Further, merged records may also be a list of communication records with the same type and having a same identifier. In particular, these communication records can be arranged from top to bottom on the interface of the mobile terminal according to the time sequence from latest to earliest. As shown in FIG. 4, the first three short messages with the identifier of “ZhangSan” and may be regarded as one merged record, the next two call logs with the identifier of “18683256579” may be regarded as another merged record, and next two call logs with the identifier of “ZhangSan” may be regarded as yet another merged record. In practical application, any other variations regarding displaying merged records may be used, which is not described in detail herein.

Block 204: determine a time of the merged record according to the generated time of the communication records. As described above, there may be multiple communication records corresponding to each merged record. These communication records are of the same type and have the same identifier. Then, compare the generated time of all the communication records corresponding to each merged record, acquire the generated time of the latest communication record among the communication records corresponding to the merged record, and obtain the generated time of the latest communication record as the time of the corresponding merged record. For example, the generated time of the communication records for three short messages with the identifier of “ZhangSan” are, respectively, “8:20 on Jul. 20, 2012”, “15:30 on Jul. 20, 2012”, and “10:10 on Jul. 21, 2012”, so the generated time of the latest communication record is “10:10 on Jul. 21, 2012”, i.e., the time of “10:10 on Jul. 21, 2012” can be regarded as the time of the corresponding merged record.

Block 205: arrange all the merged records in the same interface according to time sequence of merged records. As described above, each merged record corresponds to a time. In implementation, all the merged records can be arranged according to the time sequence of the merged records. For example, all the merged records can be arranged from top to bottom on the same interface according to the time sequence of the merged records from latest to earliest.

Because the ways of displaying merged records may be different, checking the communication records corresponding to the merged record may also be different. For example, the merged record may only include the identifier and the type of the communication records corresponding to the identifier, as shown in FIG. 3A. In practical operation, when the user needs to check specific communication records corresponding to each merged record, it is necessary to select the merged record to enter the list of the specific communication records corresponding to the merged record. In other words, after Block 205, when the user needs to check specific communication records corresponding to the merged record, it may also perform a confirm operation for the relevant merged record (the confirm operation may be implemented by button pressing or screen touching). Accordingly, when the confirm information is received for the merged record, the communication records corresponding to the merged record may be displayed according to the generated time of the communication records. For example, when the user performs the confirm operation for the first merged record in FIG. 3A, three communication records corresponding to the merged record may be displayed on the interface, as shown in FIG. 3B. In implementation, the unfolded communication records with the same type and having a same identifier may be directly displayed at the position of the merged record in the original interface, or it may also display the communication records corresponding to the merged record separately through another interface. When displaying multiple communication records corresponding to the merged record, the same type of communication records having the same identifier may be arranged according to the generated time of the communication record. For example, the communication records can be arranged from top to bottom according to the generated time of the communication records from latest to earliest.

The merged record may also be a list of communication records with the same type and having the same identifier. Generally, merging of the merged record includes: arranging the same type of communication records having the same identifier according to the generated time of the communication records and obtaining the arranged communication records with the same type and having the same identifier as one merged record. In other words, the communication records can be arranged from top to bottom on the interface of the mobile terminal according to the time sequence from latest to earliest, in which the adjacent communication records with the same type and having the same identifier are obtained as one merged record. As shown in FIG. 4, the first three short messages with the identifier of “ZhangSan” may be obtained as one merged record, and next two call logs with the identifier of “18683256579” may be obtained as one merged record. When displaying the communication records of each merged record, the communication records can be arranged from top to bottom according to the generated time of the communication records from latest to earliest.

For ease of identification, each merged record can be differentiated distinctly, for example, by colors, etc. Even different types of communication records can be differentiated distinctly, for example, by colors or icons, etc.

It should be noted that, content of short messages, identifiers, types, times, and the location relationship thereof, etc. as shown in FIG. 3A, FIG. 3B and FIG. 4 are only examples, but not intended to limit the protection scope of the present disclosure. In implementation, the merged records may not only be displayed by the above-described identifier and type, but also may be displayed by the identifier, type, and time of the merged record.

Those skilled in the art would clearly understand that the examples may be implemented by machine-readable instructions plus a necessary common hardware. As described above, according to the method for arranging communication records provided by various embodiments of the present disclosure, the communication records are classified and merged as merged records, and all the merged records are arranged according to the time sequence of the merged records, so that all the communication records can be organized and displayed in the same interface, which makes the operation and reading more convenient.

FIG. 5 is a diagram illustrating a structure of a device for arranging communication records according to various embodiments of the present disclosure. The device includes an acquiring module 501, a recording module 502, a merging module 503, and an arranging module 504.

The acquiring module 501 is configured to acquire a communication record. The recording module 502 is configured to obtain an identifier and type corresponding to the communication record. In addition, in order to better arrange communication records and merged records, the recording module 502 is further configured to obtain a generated time of the communication record at the same time. The merging module 503 is configured to merge a same type of communication records having a same identifier into one merged record. The arranging module 504 is configured to arrange all the merged records in the same interface.

In the device for arranging communication records provided by the above-described example, the aforementioned division of functional modules are described only by way of example. In practical implementation, the aforementioned functionality can be distributed to different functional modules to perform based on needs, i.e., the internal structure of the device can be divided into different functional modules to achieve all or part of the aforementioned functions. In addition, the device for arranging communication records provided by the above-described example belongs to the same idea with the method for arranging communication records. The detailed implementation of the device may refer to the method example, which is not described in detail herein.

As described above, according to the device for arranging communication records provided by various examples of the present disclosure, the communication records are classified and merged as merged records, and all the merged records are arranged in the same interface so that all the communication records can be displayed in the same interface, which makes the operation and reading more convenient.

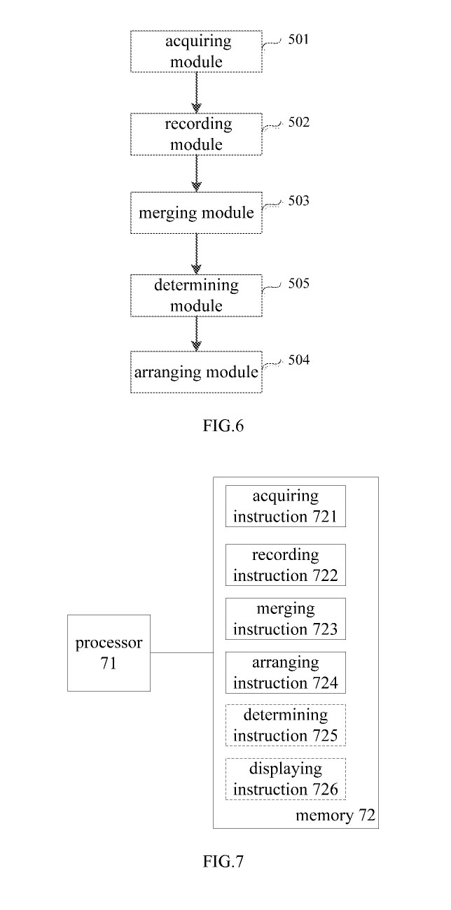

FIG. 6 is a diagram illustrating a structure of a device for arranging communication records according to various embodiments of the present disclosure. The device includes an acquiring module 501, a recording module 502, a merging module 503, an arranging module 504, and a determining module 505.

The acquiring module 501 is configured to acquire a communication record. The recording module 502 is configured to obtain an identifier and type corresponding to the communication record. In addition, in order to better arrange communication records and merged records, the recording module 502 is further configured to obtain a generated time of the communication record at the same time. The merging module 503 is configured to merge a same type of communication records having a same identifier into one merged record. The arranging module 504 is configured to arrange all the merged records in the same interface. In particular, the arranging module 504 is configured to arrange all the merged records in the same interface according to time sequence of merged records.

The determining module 505 is configured to determine a time of the merged record according to the generated time of the communication records. In particular, the determining module 505 is configured to acquire the generated time of the latest communication record corresponding to the merged record, and obtain the generated time of the latest communication record as the time of the merged record.

In practical applications, the merged record may simply include the identifier and the type of the communication records corresponding to the merged record. Thus, the device may further include a displaying module, configured to when the confirmation is received for the merged record, and display the communication records corresponding to the merged record according to the generated time of the communication records.

The merged record may also be a set of communication records of the same type and having the same identifier. In particular, the merging module is configured to: arrange the same type of communication records having the same identifier according to the generated time of the communication records, and obtain the arranged communication records with the same type and having the same identifier as one merged record.

For ease of identification, each merged record can be differentiated distinctly, for example, by colors, etc. Even different types of communication records can be differentiated distinctly, for example, by colors or icons, etc.

It should be noted that, in the device for arranging communication records provided by the above-described example, the aforementioned division of functional modules are described only by way of example. In practical implementation, the aforementioned functionality can be distributed to different functional modules to perform based on needs, i.e., the internal structure of the device can be divided into different functional modules to achieve all or part of the aforementioned functions. In addition, the device for arranging communication records provided by the above-described example belongs to the same idea with the method for arranging communication records. The detailed implementation of the device may refer to the method example, which is not described in detail herein.

As described above, according to the device for arranging communication records provided by various embodiments of the present disclosure, the communication records are classified and merged as merged records, and all the merged records are arranged according to the time sequence of the merged records, so that all the communication records can be displayed in the same interface, which makes the operation more convenient.

The numbering of the above-described examples of the present disclosure is only for description, but not intended to indicate any advantages or disadvantages of the examples.

Those skilled in the art may understand that all or part of steps in the above-described examples may be implemented by hardware, or by programs instructing related hardware. The programs may be stored in a computer-readable storage medium, such as Read-Only Memory (ROM), magnetic disk, or optical disk.

FIG. 7 is a diagram illustrating a structure of a device for arranging communication records according to various embodiments of the present disclosure. The device includes a processor 71 and a memory 72 communicated with the processor 71. In the memory 72, the instructions that are executed by the processor 71 are stored, including an acquiring instruction 721, a recording instruction 722, a merging instruction 723, and an arranging instruction 724.

The acquiring instruction 721 indicates to acquire a communication record. The recording instruction 722 indicates to obtain an identifier and type corresponding to the communication record. The merging instruction 723 indicates to merge a same type of communication records having a same identifier into one merged record. The arranging instruction 724 indicates to arrange all the merged records in the same interface. The communication record may include a generated time. Accordingly, the merging instruction 723 indicates to: arrange the same type of communication records having the same identifier according to the generated time of the communication records, and obtain the arranged communication records with the same type and having the same identifier as one merged record.

When the communication record includes a generated time, the memory 72 may further store:

a determining instruction 725 indicates to determine a time of the merged record according to the generated time of the communication records. In an example, the determining instruction 725 indicates to acquire the generated time of the latest communication record corresponding to the merged record, and obtain the generated time of the latest communication record as the time of the merged record.

Accordingly, the arranging instruction 724 indicates to arrange all the merged records in the same interface according to the time sequence of the merged records.

In an example, the communication record also includes a generated time and the merged record includes the identifier and the type of the communication records corresponding to the merged record. Thus, the memory 72 may further include a displaying instruction 726, to indicate to, when the confirm information is received for the corresponding merged record, display the communication records corresponding to the merged record according to the generated time of the communication records.

The foregoing are preferred examples of the present disclosure, which are not used for limiting the protection scope of the present disclosure. Any modifications, equivalent substitutions and improvements made within the spirit and principle of the present disclosure, should be covered by the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for arranging communication records, comprising:
acquiring a communication record;
obtaining an identifier and type corresponding to the communication record;
merging a same type of communication records having a same identifier into one merged record; and
arranging all the merged records in a same interface.

2. The method according to claim 1, wherein the communication record comprises a generated time, and merging the same type of communication records having the same identifier into one merged record comprises:
arranging the same type of communication records having the same identifier according to the generated time of the communication records, and obtaining the arranged communication records with the same type and having the same identifier as one merged record.

3. The method according to claim 1, wherein the communication record comprises a generated time, and the method further comprises:
determining a time of the merged record according to the generated time of the communication records.

4. The method according to claim 3, wherein determining the time of the merged record according to the generated time of the communication records comprises:
acquiring a generated time of a latest communication record corresponding to the merged record, and obtaining the generated time of the latest communication record as the time of the merged record.

5. The method according to claim 3, wherein arranging all the merged records in the same interface comprises:
arranging all the merged records in the same interface according to time sequence of the merged records.

6. The method according to claim 1, wherein the communication record comprises a generated time, and the merged record comprises an identifier and a type of the communication records corresponding to the merged record;
and the method further comprises:
when a confirm information is received for a merged record, displaying communication records corresponding to the merged record according to a generated time of the communication record.

7. The method according to claim 3, wherein the communication record comprises a generated time, and the merged record comprises an identifier and a type of the communication records corresponding to the merged record;
and the method further comprises:
when a confirm information is received for a merged record, displaying communication records corresponding to the merged record according to a generated time of the communication record.

8. A device for arranging communication records, comprising:
an acquiring module, configured to acquire a communication record;
a recording module, configured to obtain an identifier and type corresponding to the communication record;
a merging module, configured to merge a same type of communication records having a same identifier into one merged record; and
an arranging module, configured to arrange all the merged records in a same interface.

9. The device according to claim 8, wherein the communication record comprises a generated time, and the merging module is configured to:
arrange the same type of communication records having the same identifier according to the generated time of the communication records, and obtain the arranged communication records with the same type and having the same identifier as one merged record.

10. The device according to claim 8, wherein the communication record comprises a generated time, and the device further comprises:
a determining module, configured to determine a time of the merged record according to the generated time of the communication records.

11. The device according to claim 10, wherein the determining module is configured to:
acquire a generated time of a latest communication record corresponding to the merged record, and obtain the generated time of the latest communication record as the time of the merged record.

12. The device according to claim 10, wherein the arranging module is configured to:
arrange all the merged records in the same interface according to time sequence of the merged records.

13. The device according to claim 8, wherein the communication record comprises a generated time, and the merged record comprises an identifier and a type of the communication records corresponding to the merged record;
and the device further comprises:
a displaying module, configured to when a confirm information is received for a merged record, display communication records corresponding to the merged record according to a generated time of the communication record.

14. The device according to claim 10, wherein the communication record comprises a generated time, and the merged record comprises an identifier and a type of the communication records corresponding to the merged record;
and the device further comprises:
a displaying module, configured to when a confirm information is received for a merged record, display communication records corresponding to the merged record according to a generated time of the communication record.

15. A device for arranging communication records, the device comprises a processor and a memory communicated with the processor; in the memory, the instructions that are executed by the processor are stored, comprising an acquiring instruction, a recording instruction, a merging instruction, and an arranging instruction, wherein
the acquiring instruction indicates to acquire a communication record;
the recording instruction indicates to obtain an identifier and type corresponding to the communication record;
the merging instruction indicates to merge a same type of communication records having a same identifier into one merged record; and
the arranging instruction indicates to arrange all the merged records in the same interface.
